(19) United States
(12) Patent Application Publication
(10) Pub. No.: US 2019/0080402 A1
(43) Pub. Date: Mar. 14, 2019

(54) SYSTEM AND METHOD FOR PROVIDING A REGULATORY-COMPLIANT TOKEN

(71) Applicant: TEMPLUM, LLC, New York, NY (US)

(72) Inventors: Vincent Molinari, New York, NY (US); Christopher Pallotta, New York, NY (US)

(21) Appl. No.: 15/958,801

(22) Filed: Apr. 20, 2018

Related U.S. Application Data
(60) Provisional application No. 62/556,568, filed on Sep. 11, 2017.

(51) Int. Cl. G06Q 40/04; G06Q 40/06; G06Q 40/02; G06Q 20/06; G06Q 20/22; H04L 9/06

(52) U.S. Cl. CPC G06Q 40/04; G06Q 40/06; G06Q 40/02; H04L 2209/38; G06Q 20/223; H04L 9/0637; G06Q 20/06

(57) ABSTRACT

A method that includes generating a unique token associated with a profit participation parameter in an issuing entity for a token holder, the unique token being generated as a security according to a security regulation and being based on a determination of demand by token holders, implementing a smart contract on a blockchain to manage distributions from the issuing entity to the token holder according to the unique token, wherein the smart contract includes a set of promises in digital form and defined protocols for managing value distribution from the issuing entity to the token holder, receiving, via the smart contract, a revenue received by the issuing entity, issuing, via the smart contract and based on the revenue, to the token holder, a disbursement; and recording, by the smart contract, the disbursement and circumstances surrounding the disbursement on the blockchain.

### PRIORITY

This application claims priority to U.S. Provisional Application No. 62/556,568, filed Sep. 11, 2017, the entire content of which is herein incorporated by reference.

### TECHNICAL FIELD

The present disclosure relates to the generation of tokens or smart contracts and particularly to tokens issued as securities and in compliance with regulatory law.

### BACKGROUND

In the rapid evolution of the acceptance of initial coin offerings (ICOs) and tokenized product offerings, or any other digital asset offerings, there currently exists significant confusion about, lack of understanding of, and disregard for the manner in which monies are aggregated into tokens, and what a token actually represents. This represents a technical problem with respect to ICOs and how they are offered and how they are issued and used on a computer network.

An ICO is an unregulated means of crowdfunding via use of cryptocurrency. The term is often confused with tem “token sale” or “crowdsale”, which refers to a method of selling participation in an economy, giving investors access to the features of a particular project starting at a later date. ICOs, on the other hand, sell a right of ownership or royalties to a project. The “coin” in an ICO is a symbol or a token of ownership interest in an enterprise. It is like a digital stock certificate. In contrast to initial public offerings (IPOs), where investors gain shares in the ownership of the company, for ICOs, the investors buy coins of the company, which can appreciate in value if the business is successful.

Tokens typically take the form of a utility or special purpose token to be utilized within the ecosystem of the issuer. However, in many cases, tokens including a profit participation or revenue share determined by the token issuer are actually securities when the Howey test is applied to the tokens.

The success of ICOs has become a favorite subject of the global media due to the rapid time in which capital is aggregated and also the sheer size of token sales, which may eclipse hundreds of millions of dollars in a single issuance within weeks. This has led to tokens being misused and investors misconstruing what the tokens actually represent.

There is a significant deficiency in the messaging and the regulatory framework and protocols of what a token actually is—often, a security—and the manner in which tokens are raised. Inadequate messaging and protocols result in investors being exploited and left unprotected in the marketplace.

As a result, there is a significant need for a framework which facilitates clear issuance of tokens as securities and in compliance with regulatory law.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system configuration.

FIG. 2A illustrates a computer-implemented method embodiment;

FIG. 2B illustrates another method embodiment;

FIG. 2C illustrates another method embodiment;

FIG. 3 illustrates an example concept of a token; and

FIG. 4 illustrates an embodiment of an infrastructure supporting the method claim.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The concepts disclosed herein include uniquely designing a token offering in order to give clarity to investors as to what they are purchasing and includes embedding economic interests within tokens issued by an issuing entity, such as a company. The token offerings are tied to and aligned with the issuing entity and fiduciary obligations and investor protections are provided in that the tokens fall under the regulatory structure for securities. Such fiduciary obligations and investor protections are largely absent in the current marketplace. The solution to the computer-network-based problem with respect to initial coin offerings (ICOs) is rooted in computer technology with respect to new mechanisms technically built into tokens to provide additional clarity to investors. The offerings contemplated can be ICOs and tokenized product offerings, or any other digital asset offerings. By way of example, tokens discussed throughout the application can mean any ICO, token, or digital asset offering. The tokens are initially embedded with one or more features that will interact and can be customized and adjusted based upon the issuer's desire, which lead to a blending and/or toggling of the variables that are embedded within the token. Three example features include one or more of a yield, a profit participation/revenue share and a reward or perk-based incentive. Other features could be considered as well and this list does not mean to be exclusive. The primary claims in the present case focus on the participation or revenue share feature but can include any one or more of the features embodied within the token. A smart contract is implemented to manage the activation and implementation of the feature(s) as defined by the token. An example name of the token could be a “regcoin” for a regulated coin or “regda” for a regulated digital asset.

The offerings disclosed herein can relate to mortgages or any asset. A next generation of ICO can include a tokenized asset offering (TAO) which can include any asset such as mortgages, stocks, shares, physical assets like gold or silver, real estate, etc. Where the token relates to securities, it can be called a security token offering (STO). These can represent different kinds of ICOs with different structures as disclosed herein.

Disclosed is a computer-implemented method that includes generating a unique token associated with a profit participation parameter in an issuing entity for a token holder, the unique token being generated as a security according to a security regulation and being based on a determination of demand by token holders. The method further includes implementing a smart contract on a blockchain to manage distributions from the issuing entity to the token holder according to the unique token, wherein the smart contract includes a set of promises in digital form and defined protocols for managing value distribution from the issuing entity to the token holder. The method also includes receiving, via the smart contract, a revenue received by the issuing entity and issuing, via the smart contract and based on the revenue, to the token holder, a disbursement and recording, by the smart contract, the disbursement and circumstances surrounding the disbursement on the blockchain, wherein a record of the disbursement and the circumstances surrounding the disbursement are reviewable and immutable.

The disbursement can be additional tokens issued by the original issuing entity, one or more tokens issued by one or more third party issuers, or a quantity of fiat currency. The processor-executable instructions may be executed multiple times at a time interval. The issuer may set the disbursement size or a time interval at which the processor-executable instructions are executed.

Other aspects of this disclosure can include a smart contract associated with issued tokens, the smart contract being structured to provide a yield or a defined or stated return to the token holder. Such a yield can be an incentive to participate in the token sale. In another aspect, token holder can receive additional rewards, such as credits or discounts. By doing so, further alignment between the token holders and the issuing entity is achieved as the token holders become stakeholders in the organization in which they have invested.

One or more aspects of the tokens and/or smart contracts can be unalterable, alterable in part, or entirely alterable. For example, the confirmation, and recording performance of the smart contract may be unalterable so as to maintain the immutable and trusted nature of recording and confirming financial transactions. However, parameters associated with tokens provided by an issuing entity could be alterable after they are issued, such that, where circumstances warrant, a change in the yield, disbursement or reward structure could be modified on a single token, a group of tokens, or all issued tokens.

### DETAILED DESCRIPTION

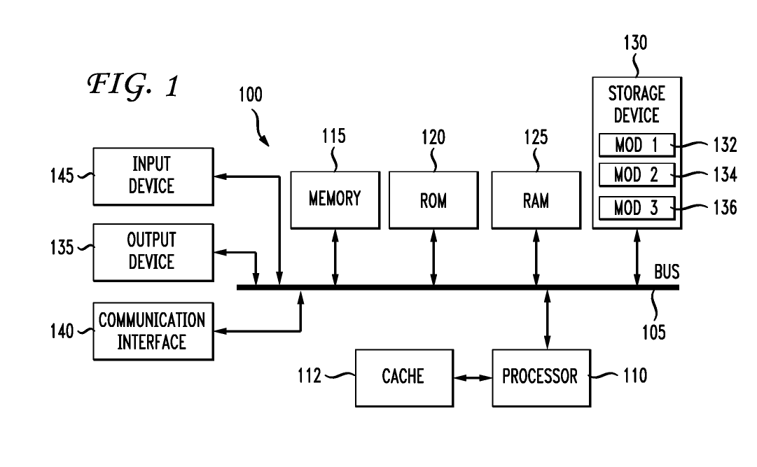

The present disclosure addresses the issues raised above. The disclosure provides a computer-implemented method embodiment. First, a general example system shall be disclosed in FIG. 1, which can provide some basic hardware components making up a server, node, or other computer system.

FIG. 1 illustrates a computing system architecture 100 wherein the components of the system are in electrical communication with each other using a connector 105. Exemplary system 100 includes a processing unit (CPU or processor) 110 and a system connector 105 that couple various system components including the system memory 115, such as read only memory (ROM) 120 and random access memory (RAM) 125, to the processor 110. The system 100 can include a cache 112 of high-speed memory connected directly with, in close proximity to, or integrated as part of the processor 110. The system 100 can copy data from the memory 115 and/or a storage device 130 to the cache 112 for quick access by the processor 110. In this way, the cache 112 can provide a performance boost that avoids processor 110 delays while waiting for data. These and other modules/services can control or be configured to control the processor 110 to perform various actions. Other system memory 115 may be available for use as well. The memory 115 can include multiple different types of memory with different performance characteristics. The processor 110 can include any general purpose processor and a hardware module or software module/service, such as MOD 1 132, MOD 2 134, and MOD 3 136 stored in the storage device 130, configured to control the processor 110 as well as a special-purpose processor where software instructions are incorporated into the actual processor design. The processor 110 may essentially be a completely self-contained computing system, containing multiple cores or processors, a bus (connector), memory controller, cache, etc. When implemented as a multi-core processor, the processor 110 may be symmetric or asymmetric.

To enable user interaction with the computing device 100, an input device 145 can represent any number of input mechanisms, such as a microphone for speech, a touch-sensitive screen for gesture or graphical input, keyboard, mouse, motion input, speech, and so forth. An output device 135 can also be one or more of a number of output mechanisms known to those of skill in the art. In some instances, multimodal systems can enable a user to provide multiple types of input to communicate with the computing device 100. A communications interface 140 can generally govern and manage the user input and system output. The system 100 is not restricted to operating on any particular hardware arrangement and therefore the basic features here may easily be substituted for improved hardware or firmware arrangements as they are developed.

The storage device 130 may be a non-volatile memory, such as a hard disk or other type of computer readable media which can store data and that is accessible by a computer. Examples of such media include, without limitation, magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules/services are contemplated. The storage device 130 can be connected to the system connector 105. In one aspect, a hardware module that performs a particular function can include a software component stored in a computer-readable medium in connection with the necessary hardware components, such as the processor 110, connector 105, display 135, and so forth, to carry out the function.

The hardware components described above can be implemented locally for an entity performing the functions disclosed herein or could be implemented in a cloud-based infrastructure or a virtual environment. The particular computer implementation of the tokens and smart contracts described herein can be on any underlying platform.

Having introduced the basic system embodiment in FIG. 1, the disclosure turns to the other figures. Disclosed herein is a unique design for token offerings that provides clarity to investors as to what they are purchasing and includes embedded economic interests with tokens issued by an issuing entity such as a company. The token offerings are tied to and/or aligned with the issuing entity and fiduciary obligations and investor protections are provided in that the tokens fall under the regulatory structure for securities. The fiduciary obligations and investor protections are largely absent in the current marketplace. The tokens will initially embed at least one feature that will interact with a smart contract or be provided as policy data to a smart contract and can be customized and adjusted based on the issuer's desire which can lead to a blending and toggling of the variables that are embedded within the token. The initial three features that are customizable and adjustable include a yield, a profit participation or revenue share, and a reward or perk based incentive. Other features embedded within the token can be personalization data about the token holder (age, income, risk tolerance, job, hobbies, social media data, purchasing habits, financial history, etc.). The following disclosure will cover various aspects of these features and how the tokens operate in connection with the smart contract to implement the yield, revenue share, profit participation, perk based incentives, and/or other value added components.

Smart contracts help to exchange money, property, shares, or anything of value in a transparent, conflict-free way while avoiding the services of a middleman. Smart contracts can be compared in terms of technology to a vending machine. Ordinarily, a client would go to a lawyer or a notary, pay them, and wait while someone retrieves a requested document. With smart contracts, the user simply drops a bitcoin into the vending machine (i.e. ledger), and the escrow, driver's license, or other item drops into their account. More so, smart contracts not only define the rules and penalties around an agreement in the same way that a traditional contract does, but also automatically enforce those obligations. For example, an option contract between parties can be written as code into the blockchain. Individuals involved in the agreement can be anonymous but the contract is the public ledger. A triggering event, such as an expiration date or a strike price being reached, may occur and the contract will automatically execute itself according to the coded terms. Regulators can use the blockchain to understand the activity in the market while at the same time maintaining the privacy of the individual actor's positions.

The following is an example of a smart contract in operation. Suppose Fred rents an apartment from Sam. The parties can do this through the blockchain by paying in cryptocurrency. Fred gets a receipt which is held in the virtual contract. Sam gives Fred the digital entry key which comes to Fred by a specified date. If the key does not come on time, the blockchain releases a refund. If Sam sends the key before the rental date, the function holds it releasing both the fee and key to Sam and Fred, respectively, when the date arrives. The system works on the “If-Then” premise and is witnessed by hundreds of people, so one can expect a faultless delivery. If Sam gives Fred the key, Sam is sure to be paid. If Fred sends a certain amount in bitcoins, Fred receives the key. The document is automatically canceled after the time, and the code cannot be interfered with by either of Sam or Fred without the other knowing since all participants are simultaneously alerted. People can use smart contracts for all sorts of situations including, without limitation, financial derivatives, insurance premiums, breach contracts, property law, credit enforcement, financial services, legal processes and crowdfunding agreements.

The following is example code for creating a digital token that is compatible with the Ethereum wallet. This is of course just an example and not meant to be exclusive. pragma solidity;

```
interface tokenRecipient { function receiveApproval(address _from, uint256 _value, address
_token, bytes _extraData) external; }
contract TokenERC20 {
  // Public variables of the token
  string public name;
  string public symbol;
  uint8 public decimals = 18;
  // 18 decimals is the strongly suggested default, avoid changing it
  uint256 public totalSupply;
  // This creates an array with all balances
  mapping (address => uint256) public balanceOf;
  mapping (address => mapping (address => uint256)) public allowance;
  // This generates a public event on the blockchain that will notify clients
  event Transfer(address indexed from, address indexed to, uint256 value);
  // This notifies clients about the amount burnt
  event Burn(address indexed from, uint256 value);
  /**
  * Constructor function
  *
  * Initializes contract with initial supply tokens to the creator of the contract
  */
  function TokenERC20(
    uint256 initialSupply,
    string tokenName,
    string tokenSymbol
  ) public {
    totalSupply = initialSupply * 10 ** uint256(decimals); // Update total supply with the
decimal amount
    balanceOf[msg.sender] = totalSupply; // Give the creator all initial tokens
    name = tokenName; // Set the name for display purposes
    symbol = tokenSymbol; // Set the symbol for display purposes
  }
  /**
  * Internal transfer, only can be called by this contract
  */
  function _transfer(address _from, address _to, uint _value) internal {
    // Prevent transfer to 0x0 address. Use burn( ) instead
    require(_to != 0x0);
    // Check if the sender has enough
    require(balanceOf[_from] >= _value);
    // Check for overflows
    require(balanceOf[_to] + _value >= balanceOf[_to]);
    // Save this for an assertion in the future
    uint previousBalances = balanceOf[_from] + balanceOf[_to];
    // Subtract from the sender
    balanceOf[_from] −= _value;
    // Add the same to the recipient
    balanceOf[_to] += _value;
    emit Transfer(_from, _to, _value);
    // Asserts are used to use static analysis to find bugs in your code. They should never fail
    assert(balanceOf[_from] + balanceOf[_to] == previousBalances);
  }
  /**
  * Transfer tokens
  *
  * Send \grave{ }_value\grave{ } tokens to \grave{ }_to\grave{ } from your account
  *
  * @param _to The address of the recipient
  * @param _value the amount to send
  */
  function transfer(address _to, uint256 _value) public {
    _transfer(msg.sender, _to, _value);
  }
  /**
  * Transfer tokens from other address
  *
  * Send \grave{ }_value\grave{ } tokens to \grave{ }_to\grave{ } on behalf of \grave{ }_from\grave{ }
  *
  * @param _from The address of the sender
  * @param _to The address of the recipient
  * @param _value the amount to send
  */
  function transferFrom(address _from, address _to, uint256 _value) public returns (bool
success) {
    require(_value <= allowance[_from][msg.sender]); // Check allowance
    allowance[_from][msg.sender] −= _value;
    _transfer(_from, _to, _value);
    return true;
  }
  /**
  * Set allowance for other address
  *
  * Allows \grave{ }_spender\grave{ } to spend no more than \grave{ }_value\grave{ } tokens on your behalf
  *
  * @param _spender The address authorized to spend
  * @param _value the max amount they can spend
  */
  function approve(address _spender, uint256 _value) public
    returns (bool success) {
    allowance[msg.sender][_spender] = _value;
    return true;
  }
  /**
  * Set allowance for other address and notify
  *
  * Allows \grave{ }_spender\grave{ } to spend no more than \grave{ }_value\grave{ } tokens on your behalf, and then ping the
contract about it
  *
  * @param _spender The address authorized to spend
  * @param _value the max amount they can spend
  * @param _extraData some extra information to send to the approved contract
  */
  function approveAndCall(address _spender, uint256 _value, bytes _extraData)
    public
    returns (bool success) {
    tokenRecipient spender = tokenRecipient(_spender);
    if (approve(_spender, _value)) {
      spender.receiveApproval(msg.sender, _value, this, _extraData);
      return true;
    }
  }
  /**
  * Destroy tokens
  *
  * Remove \grave{ }_value\grave{ } tokens from the system irreversibly
  *
  * @param _value the amount of money to burn
  */
  function burn(uint256 _value) public returns (bool success) {
    require(balanceOf[msg.sender] >= _value); // Check if the sender has enough
    balanceOf[msg.sender] −= _value; // Subtract from the sender
    totalSupply −= _value; // Updates totalSupply
    emit Burn(msg.sender, _value);
    return true;
  }
  /**
  * Destroy tokens from other account
  *
  * Remove \grave{ }_value\grave{ } tokens from the system irreversibly on behalf of \grave{ }_from\grave{ }.
  *
  * @param _from the address of the sender
  * @param _value the amount of money to burn
  */
  function burnFrom(address _from, uint256 _value) public returns (bool success) {
    require(balanceOf[_from] >= _value); // Check if the targeted balance is enough
    require(_value <= allowance[_from][msg.sender]); // Check allowance
    balanceOf[_from] −= _value; // Subtract from the targeted balance
    allowance[_from][msg.sender] −= _value; // Subtract from the sender's allowance
    totalSupply −= _value; // Update totalSupply
    emit Burn(_from, _value);
    return true;
  }
}
```

Bitcoin was essentially the first cryptocurrency to support basic smart contracts in the sense that the network can transfer value from one person to another. The network of nodes will only validate transactions if certain conditions are net. While Bitcoin is limited to the currency use case, Ethereum replaces Bitcoin's more restrictive language (a scripting language of a hundred or so scripts) and replaces it with a language that allows developers to write their own programs. Ethereum allows developers to program their own smart contracts, or “autonomous agents”. The language is “Turing-complete”, meaning it supports a broader set of computational instructions. Smart contracts can function as “multi-signature” accounts, so that funds are spent or actions may occur only when a required percentage of people agree, manage agreements between users, say, if one buys insurance from the other, provide utility to other contracts (similar to how a software library works) and/or store information about an application, such as domain registration information or membership records.

Smart contracts are likely to need assistance from other smart contracts. When someone places a simple bet on the temperature on a hot summer day, for example, it might trigger a sequence of contracts that are related. One contract would use outside data to determine the weather, and another contract could settle the bet based on the information it received from the first contract when the conditions are met. Running each contract requires Ether transactions fees, which depend on the amount of computational power required. Ethereum runs smart contract code when a user or another contract sends it a message with enough transaction fees. The Ethereum Virtual Machine then executes smart contracts in “bytecode”, or a series of ones and zeroes that can be read and interpreted by the network. While Ethereum is mentioned, any platform can be used to host the smart contracts disclosed herein.

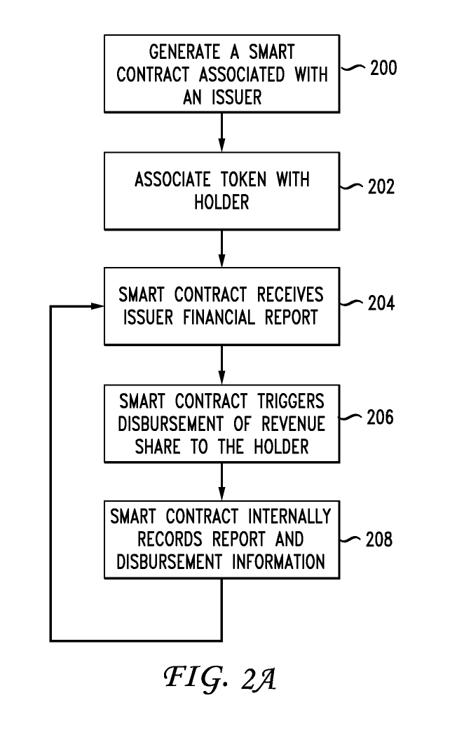

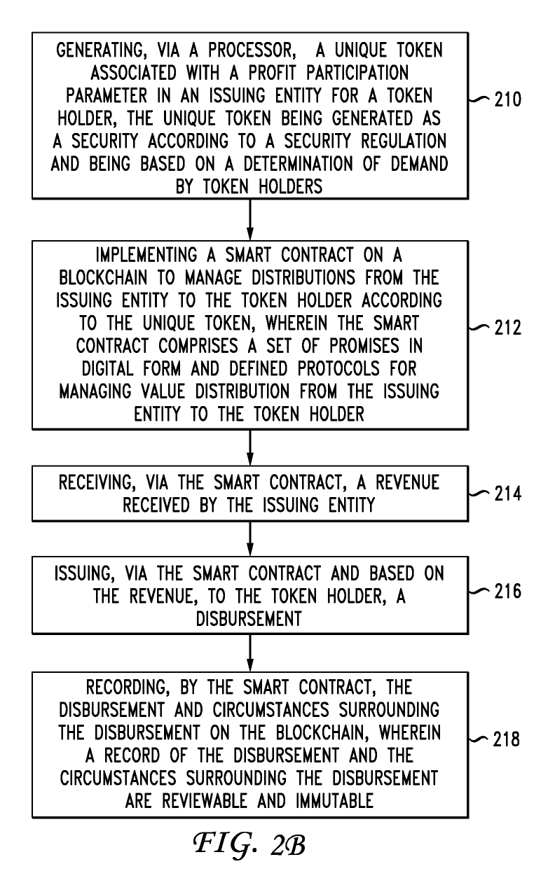

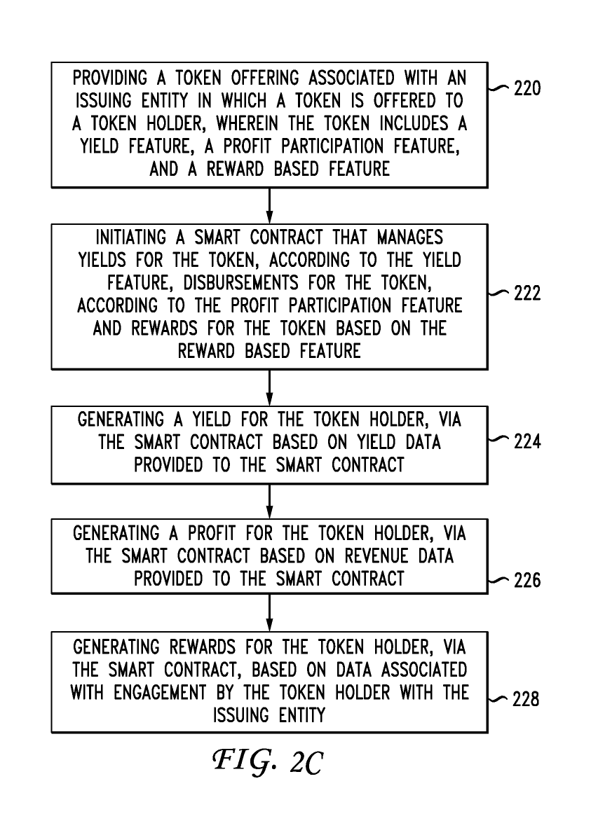

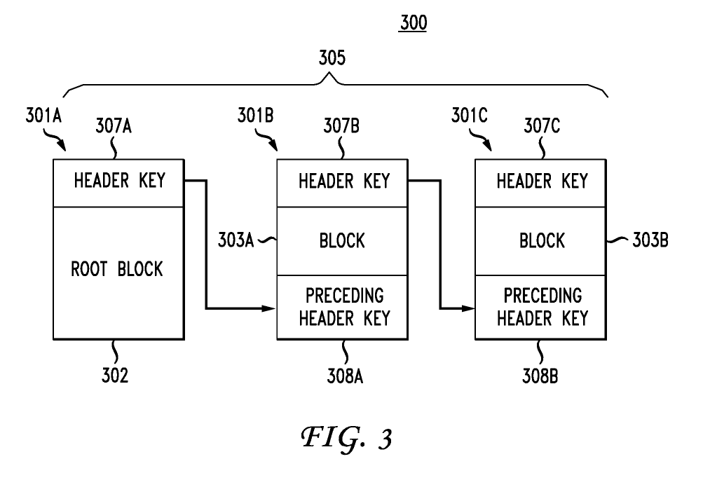

FIG. 2A illustrates a method embodiment. The method includes generating a token (step 200), which may be associated with an issuer. The token can be generated as part of a blockchain (such as the blockchain 300 described below in the discussion of FIG. 3) and issued onto the blockchain. The token may also be associated with programmable logic enabling both one-time and regularly repeated routines to be performed in association with the respective token. The token can be related to a tokenized asset offering (TAO) or a security token offering (STO).

Once the token has been generated, the method includes associating the token with a holder (step 202). The token can be associated with the holder in multiple ways which will be apparent to a person of ordinary skill in the art and other manners yet to be seen. One non-limiting example of such an association is to store the token in a wallet including an address (not depicted). A wallet can include one or more private keys enabling users to access it. A wallet may also provide an address enabling other parties to direct various digital items to it such as more tokens associated with the issuer, third party tokens or coins associated with a different issuer or altogether different token architecture, or any other of multitude of digital items or digitally described items which will be apparent to a person having ordinary skill in the art.

In the example method of FIG. 2A, once a token has been associated with a holder (step 202), the associated programmable logic discussed above then enables a smart contract to receive financial information in the form of a report from the issuer (step 204). The financial information can include, for example, revenue data of the company, and/or any other information such as historical data, founders data, product/services data, debt data, and so forth. The financial information can be retrieved by the smart contract from any number of different sources including, without limitation, an issuer database/API, a third party reporting agency, an aggregator, an Oracle, input by an authorized user, or any other number of sources which will be apparent to a person having ordinary skill in the art. The programmable logic can be stored with the smart contract itself or can be stored at a separate location and be associated with one or more tokens under the purview of the smart contract. The smart contract can initiate a request for the financial report or the smart contract can receive a push update from an external reporter.

In one aspect, any, no, or all characteristics of the tokens and/or smart contract may be alterable. For example, due to the nature of the blockchain and trusted transactions being stored and available on the blockchain, the structure of the tokens in the processes that are carried out by the smart contract are immutable and do not change. Once the tokens are issued with the particular characteristics, and once the smart contract is initiated to carry out its instructions with respect to the parameters associated with the tokens and the performance of the issuing entity, the instructions should be set and unchangeable.

In another aspect, there could be various parameters that are capable of being altered within the system. For example, tokens can embed parameters such as one or more of an expected yield, a reward, a distribution, a characteristic, and so forth. The performance and recordation component associated with such parameters is then carried out by the smart contract. For example, the smart contract may process distributions and report on the payment associated with one of the parameters of the token. In one aspect, under very limited circumstances, the instructions could be altered, such as via biometric multiple level authorization by both parties.

In one example, one part of this overall system can be alterable by an entity, such as the issuing entity, that is able to modify the embedded parameters associated with one or more of an expected yield, reward, distribution, and so forth. For example, there may be an unexpected event such as a merger or an acquisition of another company by the issuing entity, which would cause a modification of the expected yield associated with a token. The parameters, such as an extra yield or dividend, could be modified or altered by changing the associated parameter in the token, which then gets input to the smart contract via reporting or associating of the smart contract with the token. The smart contract could also be altered in this regard.

As noted, the parameters of a token may be dynamic and/or alterable by an entity. The system can be built to include the ability of an issuing entity, or any other entity, to be able to modify those parameters while maintaining the structure of the smart contract with respect to managing distributions, reporting, recording and verifying that payment transactions associated with the tokens are immutable and verifiable. In another aspect, a token holder might have the ability to alter parameters associated with the token such that adjustments could be made for their own tax planning, estate planning, inheritance, and so forth. Thus, part of the concepts disclosed herein relates to a partial alterability of characteristics of the system after tokens are issued and the functionality of the smart contract is initiated. Such alterations or modification can be made to one or more of the tokens and the smart contract itself. In one aspect, where risk has potentially changed based on some event, a token holder could pay additional money (in any currency/cryptocurrency/other value) to have a parameter associated with the token altered, such as the distribution timing or amount. A graphical or other type of user interface could be provided to enable such interactions to take place.

Furthermore, in another aspect, all components of this overall system could also be alterable. Under certain circumstances, a process carried out by the smart contract could also be altered after its initiation. For example, entities that provide revenue data, calculations on how to disperse yields or dividends or rewards, mechanisms of recording transactions, mechanisms of verifying transactions, and so forth could also be altered by one or more entities.

In another aspect, a regulatory agency may change rules on how digital assets, tokens, etc. are regulated. The smart contract could be in communication with regulatory agency servers or services such that any change that is promulgated by a regulatory agency is automatically updated by or in the smart contract. For example, restrictions on how long to hold the asset, foreign owner restrictions, restrictions on or definitions of accredited buyers, insider trading rules, etc. can be modified by or in the smart contract in view of changes by regulating agencies. An “Oracle” or similar data feed distribution system could provide a trusted data feed about regulatory agency changes. In this regard, this aspect of the disclosure includes all of the steps and operations that may be implemented in terms of transmitting data receiving data, updating protocols and so forth. The embodiments related to these processes can be claimed from a standpoint of a regulatory agency updating a law or regulation and then promulgating that update via transmission of regulatory information out to a smart contract or smart contracts that are implementing policies as described herein for token offerings. The smart contract can then modify its processes according to the updated regulations. In another aspect, an embodiment might be claimed from the standpoint of the smart contract that receives updated regulations from a regulatory agency and then modifies its internal smart contract processes to accommodate or carry out future transactions based on the updated regulations. Data associated with or embedded within tokens can also be updated as well. Blockchain-based confirmations can be established to confirm to individuals following that particular smart contract that the proper updates have been implemented, applied and confirmed via the appropriate protocols for that blockchain.

In another aspect, the potential can exist for a dynamic parameter associated with the token to be altered after the initiation of the smart contract. There can be coordination and communication of such altered data or altered parameters to the smart contract which then adapts its performance according to the updated parameters. The smart contract could even engage in a confirmation process, via the blockchain, to confirm via external data, that the updated parameters are authorized for one or more tokens. The alteration of such parameters could be on a single token, a group of tokens, or all tokens. For example, one individual might have their tokens receive an increase to yield that differs from the originally embedded yield based on some action taken by the owner of the tokens or based on some other triggering event. A group of token owners may also have their tokens modified according to a characteristic of members of the group or some triggering event such as a change in regulation related to a timing of when a token can be sold, where it could be sold or to whom it could be sold. For example, an early adoption group of token purchasers can be given an increased yield based on some event. As another example, some token holders may be in a foreign jurisdiction and the regulations associated with foreign investors might change, which can trigger an alteration of the functions associated with that group of tokens. In another aspect, all token holders can have the parameters associated with their tokens altered or updated. In all these scenarios, the updated information can be provided to the smart contract in order for the realization of dividends or payouts according to the current information.

In the exemplary method embodiment, the smart contract can trigger a disbursement of revenue share to the holder (step 206) via the associated programmable logic. For example, the revenue share can be in the form of a fiat currency disbursement from a bank account of the issuer to a bank account of the holder or it can entail providing to the holder additional tokens associated with the issuer or a cryptocurrency payment or other value paid. The revenue share could also be something else like social media data or business intelligence data. The revenue share can also be third party digital currencies such as Bitcoin, Litecoin, Ether, or any other number of digital currencies that will be apparent to a person of ordinary skill in the art. The smart contract can trigger the disbursement by sending an authorized request to an entity holding the revenue sharing device. The request can include necessary holder information as an intended recipient, issuer information as an intended sender, and transaction information. Such transaction information may include, without limitation, the context of the disbursement such as issuer financial data, the programmable logic associated with the smart contract, and a history of transactions or any other information which will be apparent to a person having ordinary skill in the art.

In the method depicted by FIG. 2A, the smart contract can internally record important information from the financial report of the issuer as well as disbursement information (step 208). The information recorded from the issuer financial report can include total revenue, growth, and/or other information apparent to a person of skill in the art. The disbursement information can include type of disbursement (e.g., Bitcoin, US Dollars, additional issuer tokens, etc.), whether or not the disbursement was successful, and other information that will be apparent to a person of skill in the art.

Depending on the programming logic associated with the token, the method can be executed to completion once or can loop on a regular schedule. As depicted by FIG. 2A, the method can return to step 204 upon completion of step 208. Step 204 can occur on a yearly, monthly, variable, or other basis determined by the issuer and implemented in the programmable logic associated with the token. The occurrence rate of step 204 can be changed after issuance of the token or can be maintained as a static rate that is unalterable for the lifetime of the token. Step 204 can be set to reoccur regularly at issuance of the token and then later be adjusted to never occur again.

FIG. 2B illustrates another aspect of this disclosure related to disbursements and smart contracts. Specifically, FIG. 2B illustrates a computer-implemented method that includes generating, via a processor, a unique token associated with a profit participation parameter in an issuing entity for a token holder, the unique token being generated as a security according to a security regulation and being based on a determination of demand by token holders (step 210). The method further includes implementing a smart contract on a blockchain to manage distributions from the issuing entity to the token holder according to the unique token, wherein the smart contract includes a set of promises in digital form and defined protocols for managing value distribution from the issuing entity to the token holder (step 212). The method also includes receiving, via the smart contract, a revenue received by the issuing entity (step 214) and issuing, via the smart contract and based on the revenue, to the token holder, a disbursement (step 216). Finally, the method includes recording, by the smart contract, the disbursement and circumstances surrounding the disbursement on the blockchain, wherein a record of the disbursement and the circumstances surrounding the disbursement are reviewable and immutable (step 218). The smart contract can receive data associated with or embedded within the token such as the policies or distribution structure, as well as other data from the token.

In one example, the instructions can be alterable by the issuing entity. The disbursement can include one or more additional tokens associated with the issuing entity or a cryptocurrency, a fiat currency, or another form of value. Additional tokens can be issued by a third-party. The instructions can be repeatedly executed at a time interval or triggered based on an internal or external event or data point. The size of the disbursement can be set by the issuing entity in whole or in part. For example, the disbursement value can be set in part by the issuing entity and its performance, revenue statistics, historical information, or future expectations, and in part by external data points such as market value demand, government regulation activity, and so forth. The time interval could also be set by the issuing entity.

In one aspect, the disbursement is issued in real-time. In other words, the smart contract is enabled to immediately act to allow for real-time distributions as it receives data that causes it to issue the disbursement. For example, as soon as the smart contract receives revenue data for the issuing entity, it can, dynamically and in real time, initiate a distribution to a token holder or token holders associated with the smart contract. At the same time, the smart contract can archive and create an audit trail of payment activity from the issuing entity to its token holders, thus providing fairness and alignment of interests across the ecosystem associated with the tokens. As noted above, the smart contract can manage disbursements to a single token holder or to multiple token holders.

FIG. 2C illustrates another method embodiment that includes providing a token offering associated with an issuing entity in which a token is offered to a token holder, wherein the token includes a yield feature, a profit participation feature, and a reward based feature (step 220). The method further includes initiating a smart contract that manages yields for the token, according to the yield feature, disbursements for the token, according to the profit participation feature and rewards for the token based on the reward based feature (step 222). A yield is generated for the token holder, via the smart contract based on yield data provided to the smart contract (step 224) and a profit is generated for the token holder, via the smart contract based on revenue data provided to the smart contract (step 226). The method further includes generating rewards for the token holder, via the smart contract, based on data associated with engagement by the token holder with the issuing entity (step 228).

The smart contract disclosed herein can also receive any data embedded within the token, such as personalized data for the token holder, or any of the yield, disbursement, and rewards data disclosed herein. The token data is also updatable by the token holder or the issuing entity, such as to change personalized data (such as to change a risk tolerance of the token holder or a change in risk to an expected disbursement), or to change yield data, disbursement data, etc. Any token data can be used to modify parameters or the performance of the smart contract to carry out the instructions of the smart contract.

FIG. 3 depicts one embodiment of a token or smart contract 300 in the form of a blockchain 305. It is understood that any number of more blocks can be included in a blockchain and the depicted blockchain 305 only provides a non-limiting example of a blockchain having three blocks 301A, B, C.

An initial block 301A includes a root block 302 and a header key 307A. Generally, header keys, such as header keys 307A-C, can be a hash key used to verify the integrity of the contents of the preceding block. Here, header key 307A is generated by hashing the contents of root block 302. Any modification to the contents of root block 302 that is hashed will result in a different header value that will not match the value of header 307A.

Block 301B includes a preceding header key 308A. Preceding header key 308A is generated by hashing the value of header key 307A. Therefore, any alteration to header key 307A will, when hashed, result in a different value than that stored in preceding header key 308A and so reveal whether the header key 307A has been altered.

Similarly, preceding header key 308B is generated by hashing the value of header key 307B and any new block added to the chain will include a preceding header key generated by hashing, e.g., the header key 307C of block 301C. Guarantees against post hoc edits are given by this intertwining of the header keys, preceding header keys, and contents of each block.

Root block 302 can contain information such as issuer identity, holder identity, and programmable logic dictating, as a non-limiting example, rules for enabling steps 202-228 of FIGS. 2A-C. Blocks 303A and 303B of blockchain 305 may include disbursement information, such as disbursement information as recorded in step 218 of FIG. 2B. Blocks 303A and 303B may include sequential disbursement information, the information of 303A occurring before the information of 303B. As discussed above, in some embodiments, root block 302 can contain scheduling rules for receiving financial information from the issuer. Furthermore, blocks 303A and 303B can contain updates to rules stored in root block 305. Alternatively, each block, 302, 303A, 303B, etc. can each include programmable logic superseding that contained in previous blocks, if any. In this way, the token may keep up with changes to disbursement rules, financial report or disbursement timing, and changes to ruling regulatory law.

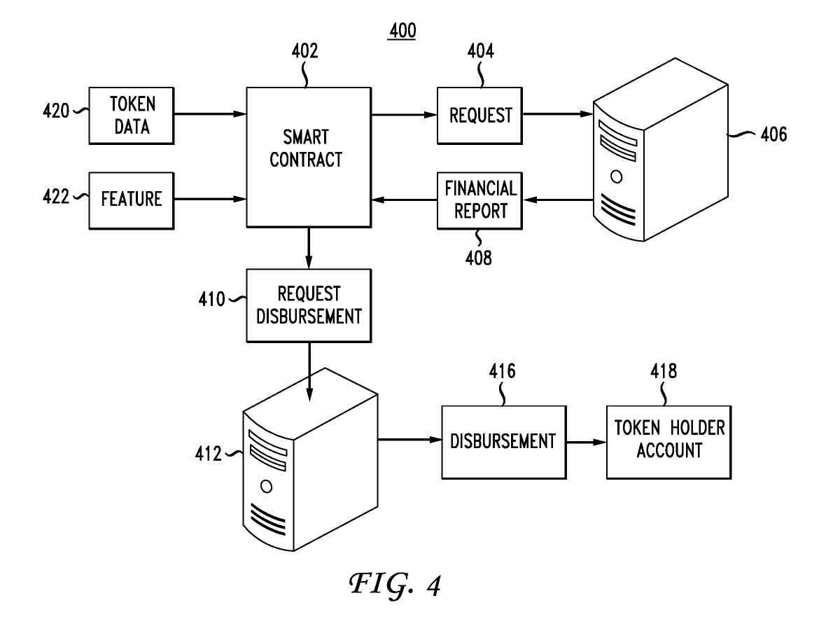

FIG. 4 depicts an embodiment of a possible architecture 400 implementing the methods described above. Architecture 400 is a non-limiting example embodiment and other embodiments will be apparent to a person having ordinary skill in the art. This embodiment illustrates a smart contract 402 and how it can receive data and carry out disbursement one or more of yields, profit sharing, or rewards that are associated with tokens issued by an issuing entity. Any token data, including personal profile data associated with the token holder, can be used to modify the performance of the smart contract.

For example, token data 420 is shown as providing information that is embedded within the token to the smart contract. The token can store or be structured in order to provide a defined or stated return that the token holder will receive as an incentive for participating in a token sale. The yield can be structured for a specific term, which can be determined by the issuing entity, to coincide with, among other things, a business plan, a cash flow, or a cash flow projection. The issuing entity can elect to create a reserved from the offering to ensure that the yield is paid to the investors for the stated term. The issuing entity can determine the yield based on global benchmarks, market demand, and token investor appetite. Any one or more of these factors can be included in the analysis. As an additional incentive to align the token holder's interest to the issuing entity, a profit participation or revenue share can also be built into the token 420. The profit participation can be programmed into the smart contract to create a transparent, trackable, defined, and immutable economic alignment of the success of the issuing entity with the token holders.

The token data 420 can provide the profit participation and revenue share data to the smart contract. Again, the profit participation parameters can be determined by the issuing entity, based on the determination of demand of token holders. These two initial variables that are embedded within the token create, in one aspect, the token structure as a security. The result of this structure is that the use of the token flows clearly within securities regulation and provides a framework for a clear fiduciary responsibility of the issuing entity to his token holders while affording the token holder investor protection under the Securities Act. One benefit of digitized securities in the form of a dynamic smart contract allows for real-time distributions, archiving, and audit trails of payment activities from the issuing entity to its token holders thus lending itself to fair play and alignment of interests across the ecosystem associated with token.

Another aspect which can be provided by implementing the concepts disclosed herein is rewards or perks-based incentives. These incentives can also be embedded within the token 420 and provided to or as part of the smart contract 402. As a result of such incentives, further alignment is achieved between token holders and the issuing entity, as consumers can become stakeholders (i.e., token holders) and stakeholders can become consumers of organizations they invest with and believe in. By creating additional incentives in the form of rewards and perks, token holders can become advocates to disseminate a message of the issuing entity to the marketplace. Such a process can increase a token holder's own engagement with the issuing entity products and services. In so doing, the token holder can receive additional rewards in the form of credits or discounts that can be used in exchange to purchase the products or services of the issuer. As token holders engage with an issuing entity and refer new customers, post to social media outlets such as Facebook, Instagram, Snapchat, and so forth, the concepts disclosed herein can enable them to receive defined points, credits or rewards from the issuing entity.

In one example, the issuer can assign ten points of credit to the token holder for posting something in regard to the issuing entity's product or services to Facebook. In another example, the token holder can receive five points of credit for uploading a picture to Instagram during the issuer's engagement. An infrastructure (server, communication modules, network-based data centers) can be developed to receive notification or data about the posting on a social media site and implement the credit for the token holder. In yet another example, centers of influence in the form of celebrities, athletes, or people or organizations with social media can be utilized to generate value for a token holder. For example, following can become a significant conduit for the issuer, while those token holders can build significant credits for utilizing services or products of the issuing entity. The activity of providing perks or reward incentives can be built into the smart contract and is fully transparent and transferable. Perks and reward incentives may be stored within the token holder's account or wallet 418, furthering the ready availability of accrued credits for use by the token holder, whether such use is in the issuer's own product or services or in exchange for goods and services of different organizations who may accept such rewards. Feature 422 represents any type of social media or rewards data that is provided to the smart contract 402. This can be publicly available data, or maybe data that is retrieved privately via a social networking site such as Facebook. It is presumed that the proper authorizations are obtained by the token holder for providing such data.

By issuing entities further aligning with other issuers in acceptance of one another's credits and tokens, a virtual circle of expanded networks of token holders can be created. The expanded network can enable engagement across the spectrum of affiliated issuers and create effective grassroots distributors from advocates of the issuing entities where aligned with their smart contract token holdings.

The smart contract 402 can include a blockchain as depicted in FIG. 3 and discussed above or can be an altogether different embodiment of the smart contract. In the context of the profit participation feature, the smart contract 402 can initiate a request 402 triggered by programmable logic associated with the smart contract 402. The programmable logic can be contained within smart contract 402 or can be stored elsewhere and have a reference to the smart contract 402. Regardless as to where the programmable logic is stored, the request 404 is transmitted to device 406.

Device 406 can be a server controlled by the issuer. In response to receiving a request 404, device 406 transmits a financial report 408 of the issuer to the smart contract 402. Upon receiving financial report 408, the smart contract 402 executes associated programmable logic. As depicted, the smart contract 402 can then transmit a disbursement request 410 to device 412. Device 412 can be a server controlled by the issuer or may be a server controlled by another entity such as a bank, third party digital currency storage, or any other entity as will be apparent to a person of ordinary skill in the art.

Device 412 initiates a disbursement 416 in response to receiving disbursement request 410. A disbursement 416 is transmitted to an account 418 associated with the token holder. As discussed above, the account 418 can be the token itself, a wallet address, a bank account, or any other holder account apparent to a person of ordinary skill in the art.

The uniquely structured benefits set forth herein yield profit participation and reward-based incentives, aside from creating differentiating economic benefits and incentives for token holders, and can create separate and distinct value and tradability of the token itself in a secondary marketplace as successive particular tokens, which can have a limited supply, garner future token or token holder appetite to engage with issuers who have alignment with their market participants and consumers. All aspects of this concept of buying and selling tokens as they are defined herein on a secondary market are considered as being disclosed herein. Steps to offer, accept an offer, purchase, exchange value, receive, transmit and so forth tokens on a secondary market are included as well as any hardware or compute-based devices and servers to implement a secondary market.

The standardization of token holders' economic interests and reward based incentives creates a best practice for token sales, investor protection, and fiduciary responsibility of issuers that are governed by securities practice, through licensed personnel, broker-dealers, exchanges, alternative trading systems, custodians, clearing, registrar and transfer within the framework of blockchain in order to facilitate the true democratization of capital formation while opening and affording investors who previously did not have access to these unique and compelling investment opportunities.

Further example token structures can be presented as follows. A structure could be categorized as a first structure which may have a luxury type component associated with it. Under this model, the issuing entity could pay a stable yield amount, and pay a profit participation component associated with the token. The reward component can be structured to provide an amount of credit that is preloaded to the token, which allows the token holder to utilize, for example, services for a luxury rental inventory or to reduce the cost of that vehicle or service as a mechanism to increase engagement of the token holder for the issuer's services. The token holder would receive varying points or credits back to the token via the smart contract for utilizing social media, promotions, or referrals. For example, in an effort to promote the brand and lifestyle, if the token holder published a Snapchat story with the vehicle or yacht, they would earn 10 points credit to the token to apply to future rentals as a discount or a credit. If they post an experience to Facebook, they would receive 15 points. For hash tagging or referring a friend over a social media network, they would receive 20 points. The integration of the reward program towards the future utilization of services would reward points to the users and encourage further engagement and loyalty of the consumers/token holders to the service provider/issuer. This approach has the additional benefit of profit participation in the token also gives the token holder the incentive to make referrals and subsequently increase the revenue of the issuer because they have a sharing in the profit, based on the success of the company.

Another example structure could be a lottery or raffle structure. In this scenario, the issuing entity will pay a stable yield and will pay a profit component and a reward component that will uniquely allow the users to participate in ticket sales based upon specific geographies, which could entail states, countries, or regions that allow the token holder to participate as a reward, or referral in the lottery/raffle. The token holder could structure the raffle to be a 50/50 structure based on a fan base, affinity group, or diaspora community where they would be enabled to participate in receiving 10 credits for each referral—enabling them to purchase future raffle tickets for future credits. The token holder may receive 1000 credits for the establishment of a 50/50 raffle. Additionally, a token holder can receive rewards in the form of a small percentage of the winnings.

In one aspect, the system can enable a user to choose which structure they desire. For example, a luxury structure with the predetermined components with respect to yield, profit sharing, and rewards program or a lottery/raffle component with it structure of a particular yield, profit component and reward component.

In another aspect, the smart contract can be programmed to permit token holders to track and archive the amounts of rewards that are generated through online referrals that would take the form of points or tokens earned for the redemption of product for the issuer/manufacturer/distributor. For example, promoting a toy manufacturer via social media or referral network would earn a predetermined number of points as well as a token for the issuer's products, which would be aggregated in a smart contract. The aggregated rewards would then be able to be redeemed for products or a specific toy of the manufacturer.

In another aspect of this disclosure, an anti-money laundering (AML) processes may also be built into the issuance of tokens. Such a structure can include AML procedures to identify purchasers and sellers. Know your client (KYC) requirements may also relate to being accredited or qualified purchasers, which is another important feature by way of investor protections. In a regulation D 506(c) offering under general solicitation, for example, the issuer can advertise to anyone and any inbound investor has to be accredited. A retail investor may not be allowed to make the purchase of a token offering under regulation D. These types of identification requirements and data associated with being a qualified investor can be embedded within one or more of the tokens or the smart contract. A verification and validation process for investors may be executed to confirm that an investor meets all regulatory requirements. For example, a service could provide personalized verification data associated with a potential investor a token issuer or to a smart contract such that a particular token holder can be identified properly and qualified properly (e.g., does the inventors have enough income, net assets, experience, etc., to purchase the tokens?), and so forth, for regulation D offerings. The purchaser may provide access to a service or to their financial data such that an automatic access could be provided through an application programming interface (API), for instance, for analyzing their capabilities.

The smart contract can include programming or functionality that receives an initial identification of a potential purchaser of tokens in the offering, and accesses databases that are authorized by the potential investor to evaluate the credit worthiness or financial condition of the investor and returns a confirmation that the investor is accredited or not. The smart contract could access, through an API or other communication mechanism, the various entities holding the data (banks, mortgage companies, car dealerships, brokers, etc.), which may be about, among other things, a home value, a bank account, investments, debt, historical financial data, and so forth for the investor to make the evaluation. The smart contract could also perform this function on a periodic basis as in some cases accreditation is to occur every 6 months. The tokens could also include parameters that tie the ongoing yield, dividend and/or rewards to the accreditation confirmation of the token holder. For example, the yield could go down or up if the smart contract, 6 months into the operation, identifies that the token holder is no longer accredited, some other event occurs which increases or decreases risk, and so forth.

Once the token is embedded with an accredited holder status, the smart contract may be subject to various resale regulations. For example, the token may be subject to a 12-month resale provision for tax purposes or other restrictions in the United States. If someone tries to transfer the token, a multisignature confirmation approach could be implemented through the smart contract that prevents the token holder from selling that token before the 1-year anniversary. Thus, regulations can be implemented through the smart contract in this manner. As noted above, updates to regulations can also be provided to the smart contract such that its processing of dividends, restrictions on sale, and so forth can be according to the current regulatory environment.

In the scenario of a Regulation S offering, the token can be embedded with a regulatory parameter, which allows a user to sell the token to a foreign investor after 40 days. If a US investor then later buys that token, the smart contract can cause it to return to a 12-month sale restriction.

The discussion above provides a number of examples of how different offerings with different regulatory structures can be baked into tokens to identify the type of offering associated with the token, which information can then be communicated to or also provided to a smart contract that is carrying out the lifecycle of the tokens and their return on investment provisions.

In another aspect, the token can be embedded with a provision that identifies the token as owned by an insider of the issuer. The identification can provide more detailed information about the insider or may be more generic. For example, if the token is owned by the CEO of the issuing entity, that information could be made available or embedded within the token. If the token holder is more of an affiliate of the issuing entity, and thus not in a key strategic position, that information could be provided as well. This information may be useful in terms of providing transparency when tokens are sold or when dividends rewards or yields are provided. This feature can be provided as an aspect of investor protection. Also, in the case of a potential purchaser of the issuing entity or of an individual token or a group of tokens, the purchaser can be aware that he or she is buying insider tokens. This information can also be dynamic where the status of a token holder may change. For example, an individual who buys tokens from the issuing entity may later join the company on their Board of Directors. Further, a CFO may hold tokens as an insider that then leave the company and no longer have an insider status. The parameters that may be embedded within individual tokens can include data that encompasses and reports the various ways of defining an insider for purposes of that token or issuing entity.

In addition, the parameters that provide dividends yields or rewards may also vary for insiders. The parameters may be enhanced or reduced for purposes of fairness or transparency where insider traders receive a specialized type of return. Using the smart contract, data can be provided with respect to, for example, different aspects of the return on investment for insiders versus average investors. All of the insider tokens can be tracked for their particular type of return relative to other investors. Therefore, if the insider tokens receive a higher yield or return, that information can be made transparent to all token holders or to those who have access to the data from the smart contract.

The smart contract can receive information about citizenship, geographic location, accredited characteristics, and so forth of sellers and buyers of tokens in a marketplace and cause or implement any regulatory changes in those transactions. Thus, restrictions on sale, modifications of yield, dividends, and/or rewards, changes in blockchain analyses and recordation requirements, and so forth, can be implemented by the smart contract as programmed and can be based on the various points of data that would be required to carry out regulatory requirements. All of the incoming and outgoing communications associated with the smart contract are included within this process.

The various external data sources would provide such information. For example, an investor in a foreign country as well as an investor in the United States could register with the service, which provides their confirmed status, of any type, which impacts how regulations are applied. Citizen status or changes to citizen status could be provided to the smart contract, which could cause a change in a regulatory requirement or function of the smart contract. Various embodiments disclosed herein can be claimed from the standpoint of the smart contract, the token holder, the issuer, or from the standpoint of the third party service providing accreditation or other data. Thus, any steps performed by any individual entity in this process can be described and claimed as part of this disclosure.

In one aspect, investors could have in a digital wallet stored locally, or at a network service, verified data that identifies and is trusted to properly identify their accreditation status, citizenship, geographic location, and so forth. In some offerings, self-identification of accreditation is not acceptable. Thus, in situations where the issuing entity has the obligation to confirm the accreditation status of a potential token holder, using an accreditation wallet or network-based confirmation service can enable the issuing entity to fulfill their requirements through the implementation of the smart contract which would communicate with and retrieve the authorization data from an accreditation digital wallet or an accreditation service. For example, the data can be retrieved through a specific API with a holder of an individual retirement account (IRA) or other investment accounts of the buyer, the buyer's mortgage holder, or any other entity that has relevant data associated with the buyer's accreditation status. The smart contract can be authorized to retrieve that data and confirm their status to fulfil the issuing entity's obligation.

A third party service can also perform this function. The accreditation for a buyer can also be stored on a blockchain and verified through a verification algorithm. Each periodic confirmation of their accreditation status can be added to the buyer's accreditation blockchain. This approach improves the process by resolving the inherent conflict of the situation where the issuer is required to confirm the accredited status of potential buyers. Further, issuers may not even really have the capability or expertise to properly accredit buyers. Using a digital wallet or third party verifier enables a token to be created and embedded as a “clean” token that is issued to a confirmed accredited buyer. Such a clean token is better configured for resale as well. Multi-signatory requirements can be required for any aspect of this disclosure to confirm data or for security purposes.

Another aspect of this disclosure relates to how to deal with mergers, acquisitions, or other changes in management of the issuing entity. For example, the tokens in this scenario are not on the capital table and would not be on the issuing entity's books as debt as the tokens are not a debt obligation. As there is a yield/reward/disbursement component to each token, there is a potential question of what happens to the token and its associated disbursement in response to a change of ownership event. A potential issue can exist if they stand to to lose their tokens in an acquisition. Several approaches can be implemented to enable the token holders to retain value or have value transferred in the context of a merger or acquisition. These solutions can protect the token holding investor when faced with such events.

One approach could simply be to enable the issuing entity and the purchasing entity to deal with the token holders in the event of a merger or acquisition. For example, if a company issues stock and raises $2M in normal regulated stock but then receives $10M from individuals who receive tokens, in the sale of that company, the regular stockholders would, in the standard fashion, receive capital gains income in process. However, the issuing entity or selling entity could arrange with the acquiring company to pay out whatever yields, dividends, or agreed-upon disbursements to the token holders as part of a merger process.

In another aspect, rules or parameters for dealing with a merger process may be embedded within the tokens. In such a scenario, information about the merger process, such as a signing of a letter of intent, or the initiation of merger discussions, the completion of due diligence, and the final funding event could be provided to the smart contract which could carry out the merger parameters that are embedded within the tokens or programmed within the contract. A merging process could also be programmed into the smart contract independent of any specific merge instructions embedded within the tokens.

In one aspect, the smart contract could be programmed to prepare for a merger event. Programming within the smart contract can be provided to the store historical information through the blockchain which can be utilized through a programmed algorithm to predict the future performance of the tokens. For example, if a token holder paid $1000 for the token and had received in dividends, yields and/or rewards a return of $1000 on their investment and there was an expected additional $2000 of income from that token over a period of several years, that information could be built into the smart contract such that a report could be provided which would provide information about an expected future income for that token holder. That data could be utilized to pay that token holder a certain amount in the event of the merger. The seller and the acquirer could agree that at the conclusion of the merger the smart contract report with respect to the token holders would be honored such that the token holders would receive compensation as part of the merger. The buying entity could also transfer the tokens to the new entity such that the same dividends/yields or rewards would continue to be paid.

The information associated with the token value as determined by the smart contract can be provided as a value to the parties and negotiated between the issuer and the acquirer. In one example, assume that on Jul. 1, 2017, data was provided to the smart contract that indicated that a merger had formally begun and that the merger was expected to take nine months. The smart contract could predict the performance of the tokens and the expected future value gains to the token holders, nine months from Jul. 1, 2017. In one example, assume that it is predicted that all of the token holders can expect on Apr. 1, 2018, that they will have an aggregated additional yield, dividend and/or rewards of $20M over a three year period. A report can be provided and utilized to enable the acquiring entity to make an offer or negotiate a buyout of the token holders. In one aspect, the purchasing entity may directly buy the interests of the token holders at which point the acquiring entity may become the token holder and receive, in the above scenario, the yield, dividends and/or rewards would be received by the new owner of the tokens. The purchasing entity could also then resell the tokens to new buyers. The original token holders may want to have their tokens transitioned to the new entity at full value or agree upon a discount to maintain the tokens in place. Of course the buyer and the token holders could also negotiate the sale of the tokens to the new buyer of the issuing entity. The report and prediction of the value of the tokens in the future from the smart contract could be provided to enable the value to be ascertained.

In another aspect, the issuing entity could place money in an account, a crypto currency or put some value at a location that is accessible by the smart contract such that if the sale event or merger event occurs, it could trigger a payment to the token holders. The trigger could occur before the merger, during the sale, or after the sale and the sale may be to fund the token holder payment account. The smart contract could be structured such that the payment would be paid to the token holders if they had not received a certain return on their investment. For example, if a token holder purchased $1000 worth of tokens and had only received $500 in dividends prior to a merger event, the issuing entity could be required to retain $600 such that as the merger event is reported to the smart contract, and if it is confirmed that it will occur or is occurring, that the token holder receives $600 from the account, which enables them to both receive their initial purchase price plus a profit. An amount of money in a holding account could also be required by the smart contract and could be adjustable as returns are provided to the token holders. For example, the amount in the account could be a dwindling amount as the token holders receive dividends such that as the token holders receive their initial payment plus a certain percentage of profit, say 20%, that the holding account then can be depleted. At this point, in one scenario, the token holders would be potentially open to losing their continued yield in the event of a merger but at the very least, the smart contract ensured that they received their initial investment plus some profit.

As is noted above, another aspect can include the smart contract creating a debt obligation for the issuing company. In the event of a merger, the smart contract could be programmed to produce a document which would represent the expected income to the token holders as an evaluation of the tokens held for the purposes of a buyout. The report can of course be modifiable or provided in the context of one year returns following the merger, two year returns, ten year returns, and so forth. Again, this report can be utilized for the purpose of providing and protecting the token holders in the merger event.

In yet another aspect, the tokens can be self-extinguishing or self-liquidating at the change in ownership event. One or more steps could potentially need to be taken before such self-extinguishing or self-liquidating event would occur and in connection with the merger event. In one aspect, once a smart contract receives the data that a merger has occurred or the type of change event has occurred, the smart contract may simply cease to operate and all of the associated tokens may self-extinguish. For example, if the merger data indicates that a merger will occur within the next three months with a certain probability, the smart contract could require a self-liquidating event where the issuing entity is required to pay the token holders a certain amount, which can be established based on the amount of capital returned, the amount of profit or rewards, as well as the predicted profit or rewards in the future, such that token holders receive at least their capital and a certain return from the issuing entity. In this scenario, the issuing entity may need to go into debt in order to pay the token holders, but that that would end up being in debt obligation on the record as part of the merger transition.

The protection features disclosed herein could be implemented as a toggle like feature within the smart contract that is essentially turned on when a merger event is initiated or on the horizon. Part of the obligations of the issuing entity to the token holders could be to provide such data with respect to mergers to the smart contract so that the protection provisions can be implemented in the event of a merger. A holding account or escrow account which stores some money or other value designed to protect token holders again could be utilized such that if merger discussions begin and the smart contract is not notified, or if a merger event occurs without the protections procedures implemented, that the value within the holding account could be retrieved and distributed to token holders in order to enable them to be made whole or receive an expected return. In other words, penalty provisions could be provided to urge the issuing entity to properly report merger discussion status to the smart contract.

By reporting the information associated with a merger, the smart contract could begin to implement protection features, such as increasing or enhancing the yield dividends or rewards. For example, if, at the initiation of merger discussions, it is expected that the merger negotiations will last one year, the smart contract could utilize the amount of capital returned, the amount of profit received, and the predicted return over that next year to make adjustments for the token holders. In one example, in order for token holders to receive a predetermined return on their investment, the smart contract might enhance all of the returns such that essentially a normal two year expectation of return would be provided to token holders within one year. In this scenario, when there tokens become extinguished as part of a merger event, the token holders are made whole without the need for the acquirer to deal with the tokens.

According to the agreed-upon parameters within the smart contract, the token holder protection provisions might also be dynamically adjusted as reports are provided throughout the merger negotiation process such that if the likelihood of a merger decreases and the process starts to break down, the return algorithms could potentially adjust returns back to their normal expected and programmed amount. The smart contract could also be implemented such that if accelerated returns are provided because of the expectation of a merger, but the merger falls through, the smart contract could reduce the returns over a period of time such that a year after the failed merger of events, the return algorithm has balanced out the returns for that period of time and is back onto a normal return schedule as though no merger discussions had occurred.

The information on the performance of the token could also be utilized to provide a value to that tokens which might be similar to a bondholder value. Depending on what the yield value is, that token might be sellable in a marketplace and the data held within the smart contract on its historical performance as well as his predicted performance can be used to establish that value.

In the issuer side of the smart contract, for example, with any of Reg A+, Reg D 506(b) or (c), Reg F, Reg C, or any other offerings, the regulatory requirements for those offerings on the issuer side can be built into the token offerings disclosed herein. The details of any regulatory statute that might apply are incorporated by reference and considered as part of this disclosure, as would be known by one of skill in the art. Any component of the requirements can be built into the tokens as well as the functioning of the smart contract. Similarly, any regulatory requirements on the buying entity, such as resale restrictions, foreign investor sale requirements, holding periods, accreditation levels, and so forth can also be built into the tokens.

In some embodiments, the computer-readable storage devices, mediums, and or memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. Any token or structure/function disclosed herein can apply to a tokenized asset offering or a security token offering.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment,” “variation,” “aspect,” “example,” “configuration,” “implementation,” “case,” and any other terms which may connote an embodiment, as used herein to describe specific features of configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other in any combination.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

Moreover, claim language reciting “at least one of” a set indicates the one member of the set or multiple members of the set satisfy the claim. For example, claim language reciting “at least one of A, B, and C” or “at least one of A, B, or C” means A alone, B alone, C alone, A and B together, A and C together, B and C together, or A, B, and C together.

What is claimed is:

1. A computer-implemented method comprising:
generating, via a processor, a unique token associated with a profit participation parameter in an issuing entity for a token holder, the unique token being generated as a security according to a security regulation and being based on a determination of demand by token holders;
implementing a smart contract on a blockchain to manage distributions from the issuing entity to the token holder according to the unique token, wherein the smart contract comprises a set of promises in digital form and defined protocols for managing value distribution from the issuing entity to the token holder;
receiving, via the smart contract, a revenue received by the issuing entity;
issuing, via the smart contract and based on the revenue, to the token holder, a disbursement; and
recording, by the smart contract, the disbursement and circumstances surrounding the disbursement on the blockchain, wherein a record of the disbursement and the circumstances surrounding the disbursement are reviewable and immutable.

2. The computer-implemented method of claim 1, wherein the unique token is alterable by the issuing entity.

3. The computer-implemented method of claim 1, wherein the disbursement comprises one or more additional tokens associated with the issuing entity.

4. The computer-implemented method of claim 1, wherein the disbursement comprises one or more tokens issued by a third-party.

5. The computer-implemented method of claim 1, wherein the disbursement comprises a quantity of a fiat currency.

6. The computer-implemented method of claim 1, wherein the computer-implemented method is repeatedly executed at a time interval.

7. The computer-implemented method of claim 6, wherein the time interval is set by the issuing entity.

8. The computer-implemented method of claim 1, wherein a size of the disbursement is set by the issuing entity.

9. The computer-implemented method of claim 1, wherein the disbursement is issued in real-time.

10. The computer-implemented method of claim 1, wherein the smart contract manages disbursements to multiple token holders.

11. A system comprising:
a processor; and
a computer-readable device storing instructions which, when executed by the processor, cause the processor to perform operations comprising:
generating a unique token associated with a profit participation parameter in an issuing entity for a token holder, the unique token being generated as a security according to a security regulation and being based on a determination of demand by token holders;
implementing a smart contract on a blockchain to manage distributions from the issuing entity to the token holder according to the unique token, wherein the smart contract comprises a set of promises in digital form and defined protocols for managing value distribution from the issuing entity to the token holder;
receiving, via the smart contract, a revenue received by the issuing entity;
issuing, via the smart contract and based on the revenue, to the token holder, a disbursement; and
recording, by the smart contract, the disbursement and circumstances surrounding the disbursement on the blockchain, wherein a record of the disbursement and the circumstances surrounding the disbursement are reviewable and immutable.

12. The system of claim 11, wherein the unique token is alterable by the issuing entity.

13. The system of claim 11, wherein the disbursement comprises one or more additional tokens associated with the issuing entity.

14. The system of claim 11, wherein the disbursement comprises one or more tokens issued by a third-party.

15. The system of claim 11, wherein the disbursement comprises a quantity of a fiat currency.

16. The system of claim 11, wherein the operations are repeatedly executed at a time interval.

17. The system of claim 16, wherein the time interval is set by the issuing entity.

18. The system of claim 11, wherein a size of the disbursement is set by the issuing entity.

19. The system of claim 11, wherein the disbursement issued in real-time.

20. The system of claim 11, wherein the smart contract manages disbursements to multiple token holders.
